(19) United States
(12) Patent Application Publication
(10) Pub. No.: US 2023/0399585 A1
(43) Pub. Date: Dec. 14, 2023

(54) LAUNDRY SPRAY COMPOSITION

(71) Applicant: Conopco, Inc., d/b/a UNILEVER, Englewood Cliffs, NJ (US)

(72) Inventors: Christopher BOARDMAN, Liandyrnog (GB); Karl BURGESS, Prenton, Wirral (GB)

(73) Assignee: Conopco, Inc., d/b/a UNILEVER, Englewood Cliffs, NJ (US)

(21) Appl. No.: 18/023,044

(22) PCT Filed: Aug. 12, 2021
(86) PCT No.: PCT/EP2021/072453

§ 371 Date: Feb. 24, 2023

(30) Foreign Application Priority Data
Sep. 9, 2020 (EP) 20195214.0

(51) Int. Cl. C11D 3/00; C11D 3/50; C11D 3/37; C11D 17/00

(52) U.S. Cl. CPC C11D 3/0005; C11D 17/0043; C11D 3/37; C11D 3/50

(57) ABSTRACT

An aqueous fabric spray composition comprising: hydrolysed protein and free perfume.

### FIELD OF INVENTION

The present invention relates to fabric spray compositions.

### BACKGROUND OF THE INVENTION

The consumer preference for fabric sprays to refresh their clothes between washes is growing. Consumers are increasingly looking for laundry products to use in between washes to reduce the frequency of laundry. Fabric sprays provide various benefits to fabrics including perfume, anti-odour and anti-wrinkle.

However there remains a need for ancillary laundry compositions which deliver new and improved benefits to fabrics during the laundry process. The compositions described herein provide an improved perfume experience for the consumer and/or improve the wicking abilities of a fabric i.e. the ability to absorb moisture from the skins surface and distribute through the fabric.

### SUMMARY OF THE INVENTION

In a first aspect of the present invention is provided an aqueous fabric spray composition comprising:
a. Hydrolysed protein; and
b. Free perfume.

In a second aspect of the present invention is provided a method of providing perfume to fabric, wherein the spray compositions as described herein are sprayed onto a fabric surface.

In a third aspect of the present invention is provided a use of a composition as described herein to provide an improved perfume experience for the consumer.

In a fourth aspect of the present invention is provided a use of a composition as described herein to provide improved moisture wicking capability of fabric treated with the composition.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Aqueous Compositions

The compositions of the present invention are aqueous fabric sprays. Preferably at least 60 wt. % of the composition is water, more preferably at least 70 wt. %.

### Hydrolysed Protein

The compositions as described herein comprise a hydrolysed protein. Compositions of the present invention preferably comprise 0.001 to 4 wt. % hydrolysed protein, preferably, 0.01 to 2 wt. % hydrolysed protein, more preferably 0.05 to 1 wt. % hydrolysed protein. Having the correct quantity of hydrolysed protein is important to achieve efficacy without nozzle blocking.

Protein hydrolysates are proteins which are obtainable by hydrolysis of proteins. Hydrolysis can be achieved by chemical reactions, in particular by alkaline hydrolysis, acid hydrolysis, enzymatic hydrolysis or combinations thereof.

For alkaline or acid hydrolysis, methods such as prolonged boiling in a strong acid or strong base may be employed.

For enzymatic hydrolysis, all hydrolytic enzymes are suitable, for example alkaline proteases. The production of protein hydrolysates are described, for example, by G. Schuster and A. Domsch in soaps and oils Fette Wachse 108, (1982) 177 and Cosm.Toil, respectively. 99, (1984) 63, by H. W. Steisslinger in Parf.Kosm. 72, (1991) 556 and F. Aurich et al. in Tens.Surf.Det. 29, (1992) 389 appeared.

The hydrolysed proteins of the present invention may come from a variety of sources. The proteins may be naturally sourced, e.g from plants or animal sources, or they may be synthetic proteins. Preferably the protein is a naturally sourced protein or a synthetic equivalent of a naturally sourced protein. A preferred class of proteins are plant proteins, i.e. proteins obtained from a plant or synthetic equivalents thereof. Preferably the protein is obtained from a plant. Preferred plant sources include nuts, seeds, beans, and grains. Particularly preferred plant sources are grains. Examples of grains include cereal grains (e.g. millet, maize, barley, oats, rice and wheat), pseudoceral grains (e.g. buckwheat and quinoa), pulses (e.g. chickpeas, lentils and soybeans) and oilseeds (e.g. mustard, rapeseed, sunflower seed, hemp seed, poppy seed, flax seed). Most preferred are cereal grains, in particular wheat proteins or synthetic equivalents to wheat proteins.

The protein hydrolyzate preferably has a weight-average molecular weight Mw in the range from 300 g/mol to 50,000 g/mol, in particular from 300 g/mol to 15,000 g/mol. The average molecular weight Mw can be determined, for example, by gel permeation chromatography (GPC) (Andrews P., “Estimation of the Molecular Weight of Proteins by Sephadex Gel Filtration”; Biochem J., 1964, 91, pages 222 to 233). The use of protein hydrolysates with average molecular weights in this range leads to a particularly effective perfume benefits.

It is preferred if the protein hydrolyzate is cationically modified. Preferably, a cationically modified wheat protein hydrolysate. Preferably the hydrolysed protein contains at least one radical of the formula:

R1—N⁺(CH₃)₂—CH₂—CH(OH)—CH₂—XR
R1 is an alkyl group having 1 to 30 carbon atoms, an alkenyl group having 1 to 30 carbon atoms, or a hydroxyalkyl group having 1 to 30 carbon atoms. R1 is preferably selected from, a methyl group, a C 10-18 alkyl, or a C 10-13 alkenyl group,
X is O, N or S
R represents the protein residue. The term “protein residue” is to be understood as meaning the backbone of the corresponding protein hydrolyzate formed by the linking of amino acids, to which the cationic group is bound.

The cationization of the protein hydrolysates with the above-described residues can be achieved by reacting the protein hydrolyzates, in particular the reactive groups of the amino acids of the protein hydrolysates, with halides which otherwise correspond to compounds of the above formula (wherein the X—R moiety is replaced by a halogen).

Wheat protein hydrolysates are commercially available, for example, from Croda under the trade name ColtideRadiance.

Hydrolyses proteins in the compositions described herein may provide an improved perfume experience for the consumer and/or improve the wicking abilities of a fabric i.e. the ability to absorb moisture from the skins surface and distribute through the fabric.

By improved perfume experience, it is meant an increased intensity on freshly sprayed and 24 hours after spraying the fabrics.

The moisture wicking capability of the fabric refers to the capability of the fabric, once dried, and in wear, to wick moisture (such as sweat) away from the skin of the wearer. The improved moisture wicking capability of synthetic fabric may be expressed in many ways, including rejuvenating sportswear, improving the lifetime of sportswear, reviving sportswear, caring for sportswear. Alternatively the improved moisture wicking capability of synthetic fabric may be expressed in terms of the benefits while the garment is being worm, for example: keeping the wearer drier for longer, keeping the wearer cooler for longer, keeping the wearer feeling comfortable for longer. In particular these benefits are seen during exercise when the wearer of the clothes is more likely to sweat.

### Perfume

The compositions of the present invention comprise free perfume.

Free perfume may be present at a level selected from: less than 10 wt. %, less than 8 wt. %, and less than 5 wt. %, by weight of the spray composition. Free perfume may be present at a level selected from: more than 0.0001 wt. %, more than 0.001 wt. %, and more than 0.01 wt. %, by weight of the spray composition. Suitably free perfume is present in the spray composition in an amount selected from the range of from about 0.0001 wt. % to about 10 wt. %, preferably from about 0.001 wt. % to about 8 wt. %, more preferably from about 0.01 wt. % to about 5 wt. %, by weight of the spray composition.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N. J. (USA). These substances are well known to the person skilled in the art of perfuming, flavouring, and/or aromatizing consumer products.

A wide variety of chemicals are known for perfume use including materials such as aldehydes, ketones, esters and the like. More commonly, naturally occurring plant and animal oils and exudates comprising complex mixtures of various chemical components are known for use as perfume, and such materials can be used herein. Typical perfumes can comprise e.g. woody/earthy bases containing exotic materials such as sandalwood oil, civet and patchouli oil. The perfume also can be of a light floral fragrance e.g. rose or violet extract. Further the perfume can be formulated to provide desirable fruity odours e.g. lime, lemon or orange.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The free perfume of the present invention is preferably in the form of an emulsion. The particle size of the emulsion can be in the range from about 1 nm to 30 microns and preferably from about 100 nm to about 20 microns. The particle size is measured as a volume mean diameter, D[4,3], this can be measured using a Malvern Mastersizer 2000 from Malvern instruments.

Without wishing to be bound by theory, it is believed that the free perfumes of this emulsion particle size will interact with the silicone emulsion to provide improved perfume longevity on the items being sprayed.

Free oil perfume forms an emulsion in the present compositions. The emulsions may be formed outside of the composition or in situ. When formed in situ, at least one emulsifier is preferably added with the free oil perfume to stabilise the emulsion. Preferably the emulsifier is anionic or non-ionic. Examples suitable anionic emulsifiers for the free oil perfume are alkylarylsulphonates, e.g., sodium dodecylbenzene sulphonate, alkyl sulphates e.g., sodium lauryl sulphate, alkyl ether sulphates, e.g., sodium lauryl ether sulphate nEO, where n is from 1 to 20 alkylphenol ether sulphates, e.g., octylphenol ether sulphate nEO where n is from 1 to 20, and sulphosuccinates, e.g., sodium dioctylsulphosuccinate. Examples of suitable nonionic surfactants used as emulsifiers for the free oil perfume are alkylphenol ethoxylates, e.g., nonylphenol ethoxylate nEO, where n is from 1 to 50, alcohol ethoxylates, e.g., lauryl alcohol nEO, where n is from 1 to 50, ester ethoxylates, e.g., polyoxyethylene monostearate where the number of oxyethylene units is from 1 to 30 and PEG-40 hydrogenated castor oil.

The compositions of the present invention may comprise one or more perfume compositions. The perfume compositions may be in the form of a mixture of free perfumes compositions or a mixture of encapsulated and free oil perfume compositions.

Preferably some of the perfume components are contained in a microcapsule. Where encapsulated perfume are present, suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the composition.

### Non-Ionic Surfactants

The spray composition of the present invention preferably comprises a non-ionic surfactant. Preferably the spray comprises 0.01 to 15 wt.% non-ionic surfactant, more preferably 0.1 to 10 wt.% non-ionic surfactant, most preferably 0.1 to 5 wt.% non-ionic surfactant. The correct amount of non-ionic surfactant is important can be important for achieving the desired delivery of the perfume. The spray may require sufficient surfactant to carry the surfactant, however too much surfactant will interfere with the action of the spray.

The non-ionic surfactants will preferably have an HLB value of 12 to 20, more preferably 14 to 18.

Examples of non-ionic surfactant materials include: ethoxylated materials, polyols such as polyhydric alcohols and polyol esters (including glycerol esters), alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R₁O(R₂O)ₓH
R₁=hydrophobic moiety.
R₂=C₂H₄ or mixture of C₂H₄ and C₃H₆ units
x=4 to 120
R1 preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.
R2 preferably comprises at least 50% C2H4, more preferably 75% C2H4, most preferably R2 is C2H4.
x is preferably 8 to 90 and most preferably 10 to 60.

Examples of commercially available, suitable non-ionic surfactants include: Genapol C200 ex. Clariant and Eumulgin CO40 ex. BASF.

### Malodour Ingredients

Compositions of the present invention preferably comprise anti-malodour ingredient(s). Malodour ingredients maybe in addition to traditional free perfume ingredients.

Anti-malodour agent may be present at a level selected from: less than 20%, less than 10%, and less than 5%, by weight of the spray composition. Suitably anti-malodour agent are present in the spray composition in an amount selected from the range of from about 0.01% to about 5%, preferably from about 0.1% to about 3%, more preferably from about 0.05% to about 2%, by weight of the spray composition.

Any suitable anti-malodour agent may be used. Indeed, an anti-malodour effect may be achieved by any compound or product that is effective to “trap”, “absorb” or “destroy” odour molecules to thereby separate or remove odour from the garment or act as a “malodour counteractant”. The odour control agent may be selected from the group consisting of: uncomplexed cyclodextrin; odour blockers; reactive aldehydes; flavanoids; zeolites; activated carbon; a mixture of zinc ricinoleate or a solution thereof and a substituted monocyclic organic compound; and mixtures thereof.

As noted above, a suitable anti-malodour agent is cyclodextrin, suitably water soluble uncomplexed cyclodextrin. Suitably cyclodextrin is present at a level selected from 0.01% to 5%, 0.1% to 4%, and 0.5% to 2% by weight of the spray composition.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings.

Preferably, the cyclodextrins are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH2—CH(OH)—CH3 or a —CH2CH2—OH group; branched cyclodextrins such as maltose-bonded cyclodextrins; cationic cyclodextrins such as those containing 2-hydroxy-3-(dimethylamino)propyl ether, wherein R is CH2—CH(OH)—CH2—N(CH3)2 which is cationic at low pH; quaternary ammonium, e.g., 2-hydroxy-3-(trimethylammonio)propyl ether chloride groups, wherein R is CH2—CH(OH)—CH2—N+(CH3)3CI—; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrinse

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odour control performance. Solubilized, water-soluble cyclodextrin can exhibit more efficient odour control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar U.S.A., Inc. and Wacker Chemicals (U.S.A.), Inc.

In embodiments mixtures of cyclodextrins are used.

“Odour blockers” can be used as an anti-malodour agent to mitigate the effects of malodours. Non-limiting examples of odour blockers include 4-cyclohexyl-4-methyl-2-pentanone, 4-ethylcyclohexyl methyl ketone, 4-isopropylcyclohexyl methyl ketone, cyclohexyl methyl ketone, 3-methylcyclohexyl methyl ketone, 4-tert.-butylcyclohexyl methyl ketone, 2-methyl-4-tert.butylcyclohexyl methyl ketone, 2-methyl-5-isopropylcyclohexyl methyl ketone, 4-methylcyclohexyl isopropyl ketone, 4-methylcyclohexyl secbutyl ketone, 4-methylcyclohexyl isobutyl ketone, 2,4-dimethylcyclohexyl methyl ketone, 2,3-dimethylcyclohexyl methyl ketone, 2,2-dimethylcyclohexyl methyl ketone, 3,3-dimethylcyclohexyl methyl ketone, 4,4-dimethylcyclohexyl methyl ketone, 3,3,5-trimethylcyclohexyl methyl ketone, 2,2,6-trimethylcyclohexyl methyl ketone, 1-cyclohexyl-1-ethyl formate, 1-cyclohexyl-1-ethyl acetate, 1-cyclohexyl-1-ethyl propionate, 1-cyclohexyl-1-ethyl isobutyrate, 1-cyclohexyl-1-ethyl n-butyrate, 1-cyclohexyl-1-propyl acetate, 1-cyclohexyl-1-propyl n-butyrate, 1-cyclohexyl-2-methyl-1-propy1 acetate, 2-cyclohexyl-2-propyl acetate, 2-cyclohexyl-2-propyl propionate, 2-cyc10hexyl-2-propyl isobutyrate, 2-cyc10hexyl-2-propyl nbutyrate, 5,5-dimethyl-1,3cyclohexanedione (dimedone), 2,2-dimethyl-1,3-dioxane-4,6-dione (Meldrum's acid), spiro-[4.5]-6,1 0-dioxa-7,9-dioxodecane, spiro-[5.5]-1,5-dioxa-2,4-dioxoundecane, 2,2-hydroxymethyl-1,3-dioxane-4,6-dione and 1,3-cyclohexadione. Odour blockers are disclosed in more detail in U.S. Pat. Nos. 4,009,253; 4,187,251; 4,719,105; 5,441,727; and 5,861,371, incorporated herein by reference.

Reactive aldehydes can be used as anti-malodour agent to mitigate the effects of malodours. Examples of suitable reactive aldehydes include Class I aldehydes and Class II aldehydes. Examples of Class I aldehydes include anisic aldehyde, o-allyl-vanillin, benzaldehyde, cuminic aldehyde, ethylaubepin, ethyl-vanillin, heliotropin, tolyl aldehyde, and vanillin. Examples of Class II aldehydes include 3-(4′-tert.butylphenyl)propanal, 2-methyl-3-(4′-tertbutylphenyl)propanal, 2-methyl-3-(4′-isopropylphenyl)propanal, 2,2-dimethyl-3-(4-ethylphenyl)propanal, cinnamic aldehyde, a-amyl-cinnamic aldehyde, and a-hexyl-cinnamic aldehyde. These reactive aldehydes are described in more detail in U.S. Pat. No. 5,676,163. Reactive aldehydes, when used, can include a combination of at least two aldehydes, with one aldehyde being selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and the second aldehyde being selected from aldehydes possessing an unsaturation alpha to the aldehyde function conjugated with an aromatic ring, and aldehydes in which the aldehyde group is on an aromatic ring. This combination of at least two aldehydes is described in more detail in WO 00/49120. As used herein, the term “reactive aldehydes” further encompasses deodourizing materials that are the reaction products of (i) an aldehyde with an alcohol, (ii) a ketone with an alcohol, or (iii) an aldehyde with the same or different aldehydes. Such deodourizing materials can be: (a) an acetal or hemiacetal produced by means of reacting an aldehyde with a carbinol; (b) a ketal or hemiketal produced by means of reacting a ketone with a carbinol; (c) a cyclic triacetal or a mixed cyclic triacetal of at least two aldehydes, or a mixture of any of these acetals, hemiacetals, ketals, hemiketals, or cyclic triacetals. These deodorizing perfume materials are described in more detail in WO 01/07095 incorporated herein by reference.

Flavanoids can also be used as anti-malodour agent. Flavanoids are compounds based on the C6-C3-C6 flavan skeleton. Flavanoids can be found in typical essential oils. Such oils include essential oil extracted by dry distillation from needle leaf trees and grasses such as cedar, Japanese cypress, eucalyptus, Japanese red pine, dandelion, low striped bamboo and cranesbill and can contain terpenic material such as alpha-pinene, beta-pinene, myrcene, phencone and camphene. Also included are extracts from tea leaf. Descriptions of such materials can be found in JP 02284997 and JP 04030855 incorporated herein by reference.

Metallic salts can also be used as anti-malodour agents for malodour control benefits. Examples include metal salts of fatty acids. Ricinoleic acid is a preferred fatty acid. Zinc salt is a preferred metal salt. The zinc salt of ricinoleic acid is especially preferred. A commercially available product is TEGO Sorb A30 ex Evonik. Further details of suitable metallic salts is provided below.

Zeolites can be used as anti-malodour agent. A useful class of zeolites is characterized as “intermediate” silicate/aluminate zeolites. The intermediate zeolites are characterized by SiO₂/AlO₂ molar ratios of less than about 10. Preferably the molar ratio of SiO₂/AlO₂ ranges from about 2 to about 10. The intermediate zeolites can have an advantage over the “high” zeolites. The intermediate zeolites have a higher affinity for amine-type odours, they are more weight efficient for odour absorption because they have a larger surface area, and they are more moisture tolerant and retain more of their odour absorbing capacity in water than the high zeolites. A wide variety of intermediate zeolites suitable for use herein are commercially available as Valfor® CP301-68, Valfor® 300-63, Valfor® CP300-35, and Valfor® CP300-56, available from PQ Corporation, and the CBV100® series of zeolites from Conteka. Zeolite materials marketed under the trade name Abscents® and Smellrite®, available from The Union Carbide Corporation and UOP are also preferred. Such materials are preferred over the intermediate zeolites for control of sulfur-containing odours, e.g., thiols, mercaptans. Suitably the zeolite material has a particle size of less than about 10 microns and is present in the spray composition at a level of less than about 1% by weight of the spray composition.

Activated carbon is another suitable anti-malodour agent. Suitable carbon material is a known absorbent for organic molecules and/or for air purification purposes. Often, such carbon material is referred to as “activated” carbon or “activated” charcoal. Such carbon is available from commercial sources under such trade names as; Calgon-Type CPG®;Type PCB®;Type SGL®;Type CAL®;and Type OL®. Suitably the activated carbon preferably has a particle size of less than about 10 microns and is present in the spray composition at a level of less than about 1% by weight of the spray composition.

Exemplar anti-malodour agents are as follows.

ODOBAN™ is manufactured and distributed by Clean Central Corp. of Warner Robins, Ga. Its active ingredient is alkyl (C14 50%, C12 40% and C16 10%) dimethyl benzyl ammonium chloride which is an antibacterial quaternary ammonium compound. The alkyl dimethyl benzyl ammonium chloride is in a solution with water and isopropanol. Another product by Clean Control Corp. is BIOODOUR CONTROL™ which includes water, bacterial spores, alkylphenol ethoxylate and propylene glycol.

ZEOCRYSTAL FRESH AIR MIST™ is manufactured and distributed by Zeo Crystal Corp. (a/k/a American Zeolite Corporation) of Crestwood, III. The liquid comprises chlorites, oxygen, sodium, carbonates and citrus extract, and may comprise zeolite.

The odour control agent may comprise a “malodour counteractant” as described in US2005/0113282A1 by which is hereby incorporated by reference. In particular this malodour counteractant may comprise a mixture of zinc ricinoleate or a solution thereof and a substituted monocyclic organic compound as described at page 2, paragraph 17 whereby the substituted monocyclic organic compound is in the alternative or in combination one or more of:
1-cyclohexylethan-1-yl butyrate;
1-cyclohexylethan-1-yl acetate;
1-cyclohexylethan-1-ol;
1-(4′-methylethyl) cyclohexylethan-1-yl propionate; and
2′-hydroxy-1′-ethyl(2-phenoxy)acetate.

Synergistic combinations of malodour counteractants as disclosed at paragraphs 38-49 are suitable, for example, the compositions comprising:
(i) from about 10 to about 90 parts by weight of at least one substituted monocyclic organic compound-containing material which is:
(a) 1-cyclohexylethan-1-yl butyrate having the structure:

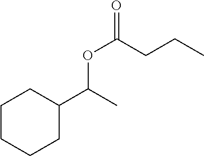

(b) 1-cyclohexylethan-1-yl acetate having the structure:

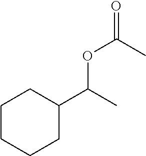

(c) 1-cyclohexylethan-1-ol having the structure:

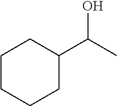

(d) 1-(4′-methylethyl)cyclohexylethan-1-yl propionate having the structure:

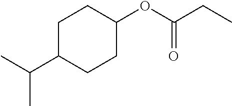

and
(e) 2′-hydroxy-1′-ethyl(2-phenoxy)acetate having the structure:

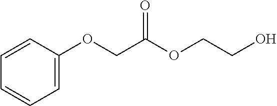 [SMILES: O=C(COc1ccccc1)OCCO]

and (ii) from about 90 to about 10 parts by weight of a zinc ricinoleate-containing composition which is zinc ricinoleate and/or solutions of zinc ricinoleate containing greater than about 30% by weight of zinc ricinoleate. Preferably, the aforementioned zinc ricinoleate-containing compositions are mixtures of about 50% by weight of zinc ricinoleate and about 50% by weight of at least one 1-hydroxy-2-ethoxyethyl ether of a More specifically, a preferred composition useful in combination with the zinc ricinoleate component is a mixture of:
(A) 1-cyclohexylethan-1-yl butyrate;
(B) 1-cyclohexylethan-1-yl acetate; and
(C) 1-(4′-methylethyl)cyclohexylethan-1-yl propionate.

More preferably, the weight ratio of components of the immediately-aforementioned zinc riconoleate-containing mixture is one where the zinc ricinoleate-containing composition: 1-cyclohexylethan-1-yl butyrate: 1-cyclohexylethan-1-yl acetate: 1-(4′-methylethyl)-cyclohexylethan-1-yl propionate is about 2:1:1:1.

Another preferred composition useful in combination with the zinc ricinoleate component or solution is a mixture of:
(A) 1-cyclohexylethan-1-yl acetate; and
(B) 1-(4′-methylethyl)cyclohexylethan-1-yl propionate.

More preferably, the weight ratio of components of the immediately-aforementioned zinc riconoleate mixture is one where the zinc ricinoleate-containing composition: 1-cyclohexylethan-1-yl acetate: 1-(4′-methylethyl)cyclohexylethan-1-yl propionate is about 3:1:1.

The anti-malodour materials of the present invention may be ‘free’ in the composition or they may be encapsulated. Suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred encapsulaing materials are aminoplasts, such as melamine formaldehyde or urea formaldehyde. The microcapsules of the present invention can be friable microcapsules and/or moisture activated microcapsules. By friable, it is meant that the perfume microcapsule will rupture when a force is exerted. By moisture activated, it is meant that the perfume is released in the presence of water.

To the extent any material described herein as an odour control agent might also be classified as another component described herein, for purposes of the present invention, such material shall be classified as an odour control agent.

### Lubricants:

The spray compositions of the present invention preferably comprise lubricants. Lubricants may be silicone based lubricants or non-silicone based lubricants.

Lubricant materials may be present at a level selected from: less than 10%, less than 8%, and less than 6%, by weight of the spray composition. Lubricant materials may be present at a level selected from: more than 0.5%, more than 1%, and more than 1.5%, by weight of the spray composition. Suitably Lubricant materials are present in the spray composition in an amount selected from the range of from about 0.5% to about 10%, preferably from about 1% to about 8%, more preferably from about 1.5% to about 6%, by weight of the spray composition.

Examples of non-silicone based lubricants include fabric softening quaternary ammonium compounds, amines, fatty acid esters, clays, waxes, polyolefins, sugar polyesters, polymer latexes, synthetic and natural oils.

Preferably the lubricant is a fabric softening quaternary ammonium compounds or a silicone-based lubricant. Most preferably the lubricant is a silicone based lubricant.

For the purposes of the present invention, fabric softening quaternary ammonium compounds are so called “ester quats”. Particularly preferred materials are the ester-linked triethanolamine (TEA) quaternary ammonium compounds comprising a mixture of mono-, di- and tri-ester linked components.

A first group of quaternary ammonium compounds (QACs) suitable for use in the present invention is represented by formula (I):

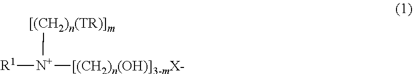

wherein each R is independently selected from a C5 to C35 alkyl or alkenyl group; R1 represents a C1 to C4 alkyl, C2 to C4 alkenyl or a Cl to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X- is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

A second group of QACs suitable for use in the invention is represented by formula (III):

(R¹)₂—N⁺[(CH₂)ₙ—T—R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X− are as defined above. Preferred materials of this third group include bis(2-tallowoyloxyethyl)dimethyl ammonium chloride, partially hardened and hardened versions thereof.

A particular example of the second group of QACs is represented the by the formula:

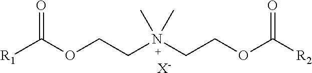

A second group of QACs suitable for use in the invention are represented by formula (V)

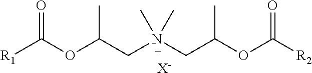

R1 and R2 are independently selected from C10 to C22 alkyl or alkenyl groups, preferably C14 to C20 alkyl or alkenyl groups. X- is as defined above.

The iodine value of the quaternary ammonium fabric conditioning material is preferably from 0 to 80, more preferably from 0 to 60, and most preferably from 20 to 50.

Silicones and their chemistry are described in, for example in The Encyclopaedia of Polymer Science, volume 11, p765.

Silicones suitable for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, siliconhydride, carboxy, phosphate, sulphonic, phosphonate, betaine, quarternized nitrogen and mixtures thereof.

Suitable non-functionalised silicones have the general formula:

R_{1—}Si(R₃)₂—O—[—Si(R₃)₂—O—]ₓ—Si(R₃)₂—R₂
R₁=hydrogen, methyl, methoxy, ethoxy, hydroxy, propoxy, and aryloxy group.
R₂=hydrogen, methyl, methoxy, ethoxy, hydroxy, propoxy, and aryloxy group.
R₃=alkyl, aryl, hydroxy, or hydroxyalkyl group, and mixtures thereof

A suitable example of a PDMS polymer is E22 ex. Wacker Chemie.

Suitable functionalised silicones may be anionic, cationic, or non-ionic functionalised silicones. The functional group(s) on the functionalised silicones are preferably located in pendent positions on the silicone i.e. the composition comprises functionalised silicones wherein the functional group(s) are located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no functional groups located on a terminal position of the silicone. When the silicones are branched in nature, the terminal position is deemed to be the two ends of the longest linear silicone chain. Preferably no functional group(s) are located on the terminus of the longest linear silicone chain.

Preferred functionalised silicones are those that comprise the anionic group at a mid-chain position on the silicone. Preferably the functional group(s) of the functionalised silicone are located at least five Si atoms from a terminal position on the silicone. Preferably the functional groups are distributed randomly along the silicone chain.

For best performance, it is preferred that the silicone is selected from: carboxy functionalised silicone; anionic functionalised silicone; non-functionalised silicone; and mixtures thereof. More preferably, the silicone is selected from: carboxy functionalised silicone; amino functionalised silicone; polydimethylsiloxane (PDMS) and mixtures thereof. Preferred features of each of these materials are outlined herein. Most preferably the silicone is selected from amino functionalised silicones; polydimethylsiloxane (PDMS) and mixtures thereof.

A carboxy functionalised silicone may be present as a carboxylic acid or an carbonate anion and preferably has a carboxy group content of at least 1 mol % by weight of the silicone polymer, preferably at least 2 mol %. Preferably the carboxy group(s) are located in a pendent position, more preferably located at least five Si atoms from a terminal position on the silicone. Preferably the caboxy groups are distributed randomly along the silicone chain. Examples of suitable carboxy functional silicones include FC 220 ex. Wacker Chemie and X22-3701E ex. Shin Etsu.

An amino functionalised silicone means a silicone containing at least one primary, secondary or tertiary amine group, or a quaternary ammonium group. The primary, secondary, tertiary and/or quaternary amine groups are preferably located in a pendent position, more preferably located at least five Si atoms from a terminal position on the silicone. Aminosilicones suitable for use in the invention will preferably have an amine content of the composition of 0.001 to 3 meq/g, more preferably 0.01 to 2.5 meq/g, most preferably 0.05 to 1.5 meq/g, which is measured as the consumption of 1 N hydrochloric acid in ml/g by the composition on titration to the neutral point. Peferably the amino groups are distributed randomly along the silicone chain. Examples of suitable amino functional silicones include FC222 ex. Wacker Chemie and EC218 ex. Wacker Chemie.

The molecular weight of the silicone polymer is preferably from 1,000 to 500,000, more preferably from 2,000 to 250,000 even more preferably from 5,000 to 200,000.

The silicone of the present invention is in the form of an emulsion. Silicones are preferably emulsified prior to addition to the present compositions. Silicone compositions are generally supplied from manufacturers in the form of emulsions. The average particle size of the emulsion is in the range from about 1 nm to 150nm, preferably 1nm to 100 nm. This may be referred to as a micro emulsion. The particle size is measured as a volume mean diameter, D[4,3], this can be measured using a Malvern Mastersizer 2000 from Malvern instruments.

### Setting Polymers

The fabric spray of the present invention may preferably further comprise one or more setting polymers. “setting polymer” means any polymer which refers to polymer having properties of film-formation, adhesion, or coating deposited on a surface on which the polymer is applied. For the avoidance of doubt if a setting polymer is present in the compositions described herein, this is in addition to the hydrolysed protein polymer.

The setting polymer may be present at a level selected from: less than 10%, less than 7.5%, and less than 5%, by weight of the spray composition. The setting polymer may be present at a level selected from: more than 0.5%, more than 1%, and more than 1.5%, by weight of the spray composition. Suitably the setting polymer is present in the spray composition in an amount selected from the range of from about 0.5% to about 10%, preferably from about 1% to about 7.5%, more preferably from about 1.5% to about 5%, by weight of the fabric spray composition.

The molecular weight of the setting polymer is preferably from 1,000 to 500,000, more preferably from 2,000 to 250,000 even more preferably from 5,000 to 200,000.

The setting polymer according to the present invention may be any water-soluble or water dispersible polymer. Preferably the polymer is a film-forming polymer or mixture of such polymers. This includes homopolymers or copolymers of natural or synthetic origin having functionality rendering the polymers water-soluble such as hydroxyl, amine, amide or carboxyl groups. The setting polymers may be cationic, anionic, non-ionic or amphoteric. The polymers make be a single species of polymer or a mixture thereof. Preferably the setting polymer is selected from: anionic polymers, non-ionic polymers, amphoteric polymers and mixtures thereof. For all polymers herein described it is intended to cover both the acids and salts thereof.

Suitable cationic setting polymers are preferably selected from the group consisting of: quaternized acrylates or methacrylates; quaternary homopolymers or copolymers of vinylimidazole; homopolymers or copolymers comprising a quaternary dimethdiallyl ammonium chloride; cationic polysaccharides; cationic cellulose derivatives; chitosans and derivatives thereof; and mixtures thereof. For example, hydroxyethylcellulose dimethyldiallyammonium chloride [PQ4] sold as Celquat L200 ex. Akzo Nobel, Quaternized hydroxyethylcellulose [PQ10] sold as UCARE JR125 ex Dow Personal Care, Hydagen HCMF ex. Cognis and N-Hance 3269 ex Ashland.

Suitable anionic setting polymers may be selected from polymers comprising groups derived from carboxylic or sulfonic acids. Copolymers containing acid units are generally used in their partially or totally neutralized form, more preferably totally neutralized. Suitable anionic setting polymer may comprise: (a) at least one monomer derived from a carboxylic acid or sulfonic acid such or their salts and (b) one or more monomers selected from the group consisting of: esters of acrylic acid and/or methacrylic acid, acrylate esters grafted onto a polyalkylene glycol, hydroxyesters acrylate, acrylamides, methacrylamides which may or may not be substituted on the nitrogen by lower alkyl groups, hydroxyalkylated acrylamide, amino alkylated, alkylacrylamine, alkylether acrylate, monoethylenic monomer, styrene, vinyl esters, allyl esters or methallyl esters, vinyllactams, alkyl maleimide, hydroxyalkyl maleimide, and mixtures thereof. When present the anhydride functions of these polymers can optionally be monoesterified or monoamidated. Alternatively, the anionic setting polymer may be selected from a water-soluble polyurethane, anionic polysaccharides and combinations thereof. Preferred anionic setting polymers may be selected from: copolymers derived from acrylic acid such as the acrylic acid.

Non-ionic setting polymers may be natural, synthetic or mixtures thereof. Synthetic non-ionic setting polymers are selected from: homopolymers and copolymers comprising: (a) at least one of the following main monomers: vinylpyrrolidone; vinyl esters grafted onto a polyalkylene glycol; acrylate esters grafted onto a polyalkylene glycol or acrylamide and (b) one or more other monomers such as vinyl esters, alkylacrylamine, vinylcaprolactam, hydroxyalkylated acrylamide, amino alkylated acrylamide, vinyl ether; alkyl maleimide, hydroxyalkyl maleimide, and mixtures thereof. Suitable natural non-ionic setting polymers are water-soluble. Preferred natural non-ionic polymers are selected from: non-ionic polysaccharides including: non-ionic cellulose, non-ionic starches, non-ionic glycogens, non-ionic chitins and non-ioinc guar gums; cellulose derivative, such as hydroxyalkylcelluloses and mixtures thereof. The non-ionic setting polymers are preferably selected from vinylpyrrolidone/vinyl acetate copolymers and such as vinylpyrrolidone homopolymer.

Amphoteric setting polymers may be natural, synthetic or a mixture thereof. Suitable synthetic amphoteric setting polymers include those comprising: an acid and a base like monomer; a carboxybetaine or sulfobetaine zwitterionic monomer; and an alkylamine oxide acrylate monomer. An example of such an amphoteric setting polymer is acrylates/ethylamine oxide methacrylate sold as Diaformer Z 731 N by Clariant; and mixtures thereof.

Preferably the setting polymer is selected from acrylate polymers, co-polymers comprising acrylate monomers, starches, celluloses, derivatives of cellulose and mixtures thereof.

Most preferably the setting polymer is selected from the group consisting of: acrylates and copolymers of two or more acrylate monomers such as:(meth)acrylic acid or one of their simple esters; octylacrylamide/acrylate/butylaminoethyl methacrylate copolymers; acrylates/hydroxyesters acrylates copolymers of butyl acrylate, methyl methacrylate, methacrylic acid, ethyl acrylate and hydroxyethyl methacrylate; polyurethane-14/AMP-acrylates copolymer blend; and mixtures thereof. This includes both the acids and salts thereof.

### Optional Ingredients

The compositions of the present invention may contain further optional laundry ingredients. Such ingredients include preservatives (including biocides) pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials, antivirals and antifungals, thickeners and skin benefit agents.

### Spray Bottle

The compositions are fabric spray compositions. By this is meant that the compositions are suitable for spraying onto a fabric. They may be sprayed by any suitable spraying device. Preferably the spray device is a manually operable spray device in the sense that the spray mechanism is manually operable to discharge a dose of said composition from the nozzle. The spray mechanism may be operated by an actuator. The actuator can be a push actuator or a pull actuator. The actuator may comprise a trigger. The spray mechanism may comprise a hand-operable pump. Optionally, said pump is one of: a positive displacement pump; a self-priming pump; a reciprocating pump. Suitable spray devices include trigger sprays, continuous/semi-continuous sprays, finger pump sprays, vibrating mesh device output sprays.

Preferably the spray device is operable without the use of a propellant. Indeed, propellant-free spray devices are preferred. This allows the spray to maintain the integrity and purity of the product, uncontaminated with propellant and is preferably environmentally.

Preferably the spray device is pressurised. This can improve spray duration and velocity. Preferably the spray device is pressurised by a gas chamber, separate from the reservoir containing the composition. The gas is preferably air or nitrogen. The spray device may comprise an outer container containing the composition and a pressurizing agent, wherein the composition is segregated from the pressurizing agent by containment (preferably hermetically sealed) in a flexible pouch. This which maintains complete formulation integrity so that only pure (i.e. excludes pressurising agent) composition is dispensed. Preferred systems are the so-called ‘bag-in-can’ (or BOV, bag-on-valve technology). Alternatively, the spray device may comprise piston barrier mechanism, for example EarthSafe by Crown Holdings.

Preferably the spray device comprises a biodegradable plastic material.

The spray mechanism may further comprise an atomiser configured to break up said liquid dose into droplets and thereby facilitate creation of said fine aerosol in the form of a mist. Conveniently, said atomiser may comprise at least one of: a swirl chamber and a lateral dispersion chamber. Suitably, the atomiser functions to mix air with the aqueous fabric spray composition.

The particle size of the formulation when sprayed is preferably no more than 300 μm, preferably no more than 250 μm, preferably no more than 150 μm, preferably no more than 125 μm, preferably no more than 100 μm. The particle size of the formulation when sprayed is preferably at least 5 μm, preferably at least 10 μm, preferably at least 15 μm, preferably at least 20 μm, preferably at least 30 μm, preferably at least 40 μm. Suitably the spray comprises droplets having an average diameter in the range of preferably 5 to 300 μm, more preferably 10 to 250 m, most preferably 15 to 150 μm.

This size allows for homogeneous distribution and a balance between sufficient wetting of the fabric, without potential fabric damage caused by excessive dosing of certain ingredients. Droplet size may be measured on a Malvern Spraytec instrument, with the peak maximum corresponding to the average droplet size. The parameter droplet size is the volume mean diameter, D[4,3]. Suitably, following actuation, the spray has a duration in the range of at least 0.4 seconds. Preferably the spray has a duration of at least 0.8 seconds. A longer duration minimises the effort by maximising coverage per actuation of a spray device. This is an important factor for products designed to be used over the full area of garments. Preferably the spray duration is directly linked to actuation such that the spray output continues only as long as the actuator is activated (e.g. as long as a button or trigger is pressed).

Spray reservoirs may be non-pressurised, manually or mechanically pre-pressurised devices. The above also to removable/refillable reservoirs.

According to a further aspect of the present invention, there is provided a replacement reservoir for a garment refresh product according to the above aspect(s), the replacement reservoir being pre-filled with a volume of said spray composition for replenishment of said product. A suitable “refill kit” comprises one or more reservoirs. In the case of more than one reservoir, for example two, three, four, five, or more reservoirs, the contents (aqueous fabric spray composition) of each reservoir may the same as or different from the other reservoirs.

### Dose

Conveniently, the spray composition is provided as a liquid, and said spray mechanism is operable to discharge a dose of at least 0.1 ml, preferably at least 0.2 ml, more preferably at least 0.25 ml, more preferably at least 0.3 ml, more preferably at least 0.35 ml, more preferably at least 0.35 ml, more preferably at least 0.4 ml, more preferably at least 0.45 ml, and most preferably at least 0.5 ml.

Suitably the dose is no more than 2 ml, preferably no more than 1.8 ml, preferably no more than 1.6 ml, more preferably no more than 1.5 ml, more preferably no more than 1.4 ml, more preferably no more than 1.3 ml, and most preferably no more than 1.2 ml.

Suitably the dose is between 0.1 and 2 ml of said liquid spray composition, preferably between 0.2 and 1.8 ml, more preferably 0.25 to 1.6 ml, more preferably 0.25 to 1.5 ml, and most preferably 0.25 to 1.2 ml.

These doses have been found to be particularly effective at achieving the desired garment refresh effect without unsightly and wasteful large droplet formation.

The dose may alternatively be defined as ml per m² of fabric. Preferably the spray composition of the present invention is dosed as 0.1 to 20 ml per m². More preferably 0.5 to 15 ml per m² and most preferably 1 to 10 ml per m².

### Method of Use

In one aspect of the present invention, there is provided a method of spraying the composition described herein onto a fabric. More particularly a method of providing an improved perfume experience for the consumer and/or a method of providing improved moisture wicking capability of fabric treated with the composition.

### Use

In one aspect of the present invention, there is provided a use of the composition according to the present invention. The composition may be used to providing an improved perfume experience for the consumer and/or providing improved moisture wicking capability of fabric treated with the composition.

In one aspect of the present invention there is provided the use of the spray compositions described herein to provide an improved (increased) perfume experience to the consumer, in particular on freshly sprayed and 24 hours after spraying a fabric.

In another aspect of the present invention there is provided the use of the spray compositions described herein to provide improved moisture wicking capability of fabric, preferably synthetic fabric, most preferably polyester. The moisture wicking capability of the fabric refers to the capability of the fabric, once dried, and in wear, to wick moisture (such as sweat) away from the skin of the wearer. The improved moisture wicking capability of synthetic fabric may be expressed in many ways, including rejuvenating sportswear, improving the lifetime of sportswear, reviving sportswear, caring for sportswear. Alternatively the improved moisture wicking capability of synthetic fabric it may be expressed in terms of the benefits while the garment is being worm, for example: keeping the wearer drier for longer, keeping the wearer cooler for longer, keeping the wearer feeling comfortable for longer. In particular these benefits are seen during exercise when the wearer of the clothes is more likely to sweat.

The use of a spray composition as described herein may provide a cumulative benefit, in particular after 5 applications. By 5 spray or application benefit it is meant that the improved moisture wicking benefit is particularly evident after 5 applications of the fabric spray formulation. The fabric may be washed between applications.

The use to provide improved moisture wicking capability of fabric is preferably for synthetic fibres. Synthetic fibres are fibres made by chemical synthesis, as opposed to natural fibres that are directly derived from living organisms. Examples of synthetic fibres are polyester, nylon, polyvinyl chloride (PVC), spandex/lycra/elastane and acrylic fibres. The fabric comprising synthetic fibres preferably comprises 20 wt. % to 100 wt. % synthetic fibres, more preferably 40 wt. % to 100 wt. % synthetic fibres, more preferably 60 wt. % to 100 wt. % synthetic fibres and most preferably 80 wt. % to 100 wt. % synthetic fibres by weight of the fabric. Preferably the use to provide improved moisture wicking capability of fabric is for treating fabric comprising 20 wt. % to 100 wt. % polyester, more preferably 40 wt. % to 100 wt. % polyester, more preferably 60 wt. % to 100 wt. % polyester and most preferably 80 wt. % to 100 wt. % polyester by weight of the fabric. Preferably the use to provide improved moisture wicking capability of fabric is for treating fabric comprising only synthetic fibres (i.e. 100% synthetic fibres), most preferably the fabric comprises 100% polyester.

### EXAMPLE COMPOSITIONS

TABLE 1
Aqueous spray compositions

| | Inclusion % by weight | |
|---|---|---|
| Ingredient | 1 | 2 |
| Hydrolysed protein ¹ | 0.5 | 1 |
| Free perfume | 0.4 | 0.2 |
| PEG-40 hydrogenated | 1.5 | 0.08 |
| castor oil | | |
| Malodour counteractant | — | 0.02 |
| Amino silicone emulsion² | — | 2 |
| Polyacrylate co-polymer | — | 0.2 |
| Water | To 100 | To 100 |

Hydrolysed protein
¹ Coltide radiance ex. Croda Amino silicone emulsion
²FC222 ex. Wacker Chemie

1. An aqueous fabric spray composition comprising;
a. Hydrolysed protein; and
b. Free perfume.

2. The aqueous fabric spray composition according to claim 1, wherein the hydrolysed protein is a plant protein.

3. The aqueous fabric spray composition according to claim 1, wherein the protein is a wheat protein.

4. The aqueous fabric spray composition according to claim 1, wherein the composition comprises 0.001 to 4 wt. % hydrolysed protein.

5. The aqueous fabric spray composition according to claim 1, wherein the composition comprises 0.0001 wt.% to about 10 wt. % free perfume.

6. The aqueous fabric spray composition, according to claim 1, wherein at least 25 wt. % of the free perfume, includes perfume ingredients having a LogP of 1 to 5.

7. The aqueous fabric spray composition, according to claim 1, wherein the composition further comprises non-ionic surfactant.

8. The aqueous fabric spray composition, according to claim 1, wherein composition further comprises malodour ingredients.

9. The aqueous fabric spray composition, according to claim 1, wherein composition further comprises lubricants.

10. The aqueous fabric spray composition, according to claim 1, wherein the composition further comprises setting polymers.

11. The aqueous fabric spray composition, according to claim 1, wherein in the composition is contained in a spray bottle.

12. A method of providing perfume to a fabric, wherein the spray compositions according to 1 is sprayed onto the fabric surface.

13. The method according to claim 12, wherein 0.1 to 20 ml per m2 of the spray composition is sprayed onto the fabric surface.

14. The method according to claim 12 wherein the fabric has improved moisture wicking capability after being sprayed with the composition.
